(19) United States
(12) Patent Application Publication
(10) Pub. No.: US 2015/0244777 A1
(43) Pub. Date: Aug. 27, 2015

(54) MASSIVELY DISTRIBUTED CLOUD-BASED PLATFORM PROVIDING FEATURES AS A SERVICE TO SUPPORT MOBILE AND WEB APPLICATIONS

(71) Applicant: GO FACTORY, LLC, San Farncisco, CA (US)

(72) Inventor: Bryan K. Hughes, San Francisco, CA (US)

(21) Appl. No.: 14/432,180

(22) PCT Filed: Sep. 27, 2013
(86) PCT No.: PCT/US2013/062365

§ 371 Date: Mar. 27, 2015

Related U.S. Application Data
(60) Provisional application No. 61/707,038, filed on Sep. 28, 2012.

(51) Int. Cl. H04L 29/08

(52) U.S. Cl. CPC H04L 67/10; H04L 67/02

(57) ABSTRACT

A method and apparatus for implementing a massively distributed cloud-based platform providing features as a service to support mobile and web applications via native client SDKs. Functionality is fully featured hosted remotely but called natively allowing a consistent logic across a plurality of devices and applications. The platform is a highly distributed process based computational and data systems cluster whereby each node manages a set of messaging channels supporting multiple concurrent endpoints.

### BACKGROUND

This invention provides a software solution to enable mobile devices as well as web applications with limited compute power the ability to execute complex functionality on considerably more powerful resources in the cloud, as if they were processed locally by the mobile or web application.

The present invention is in the technical field of distributed computing, as well as mobile and web services, or more specifically, methods and systems for distributed messaging via a channel architecture, process based services with multiple channel end points, and the feature of seamlessly moving a channel process between nodes anywhere in the world.

The advent of smartphone systems such as those running iOS and Android operating systems has transformed not only the way people communicate, but also more fundamentally how they live. With over one million mobile apps and counting as of this writing, the pace of new app development dwarfs the release of other kinds of media.

Initially, there was a rush of native app development, which quickly proved problematic with the arrival of Android requiring the development and maintenance of multiple code bases for each mobile OS. This, coupled with the need for rapid deployment of functionality, resulted in a shift from pure native apps to HTML5-based mobile apps delivered by a web server running in an HTML container or browser. Unfortunately it quickly became apparent that this circumvented much of the functionality native to the device and OS specifically designed to gracefully manage the very limited resources of the mobile device. Today, the move is to a hybrid solution where the applications have moved back to being fully native with the attempt to keep some functionality as web based. This solution does not scale well and is disjointed to the fragile nature of mobile networking.

### SUMMARY

Considered broadly, the present invention discloses a novel solution whereby through a set of computational and programmatic electronic methods, specific features are executed remotely as a service through a procedural call while having the effect of being local in the native application for mobile and web applications. The invention allows a mobile or web application to open one or more channels as a message bus from one or more devices, which may include one or more other devices, to a node in a distributed cluster for the purpose of performing logic necessary for the function of the native application. Each channel is formally a process whose state is persisted to a distributed data store, and is able to be relocated or restored on demand to any node in the cloud, regardless of physicality.

Other principal features and advantages of the invention will become apparent to those skilled in the art upon review of the following drawings, the detailed description, and the appended claims.

### BRIEF DESCRIPTION OF THE DRAWINGS

Example embodiments will hereafter be described with reference to the accompanying drawings, wherein like numerals denote like elements. The drawings depict example embodiments in accordance with the disclosure and are, therefore, not to be considered limiting of its scope.

FIG. 1 is a high-level diagram of the present invention in accordance with an example embodiment.

FIG. 2 depicts another high-level functional diagram detailing the distributed channel architecture of the platform.

FIG. 3 depicts a flow diagram illustrating the execution of a remote procedure call.

FIG. 4 depicts a functional diagram of how a given channel can be relocated or restored to a different node.

### DETAILED DESCRIPTION

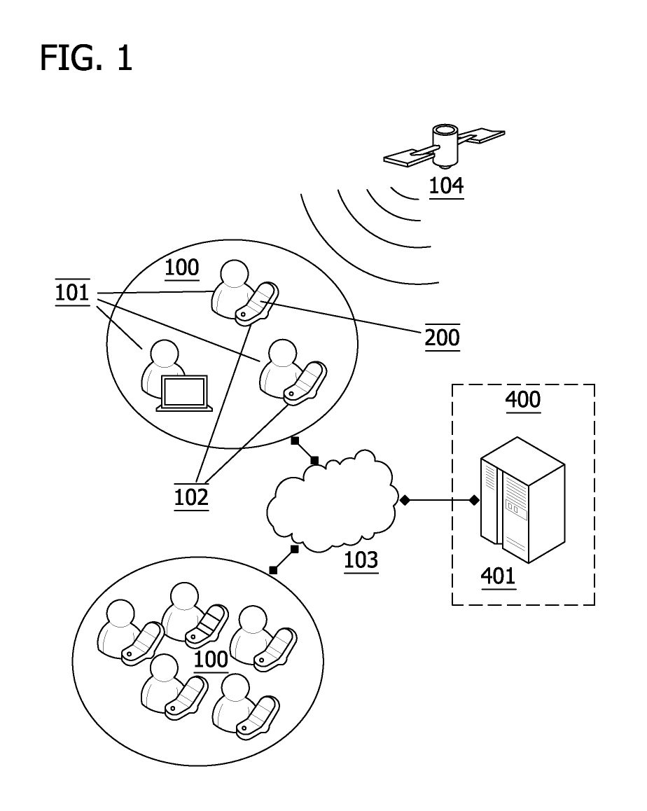

Referring now to the invention in more detail, in FIG. 1, a high level diagram of the invention is shown in accordance with an example embodiment. The invention includes device management, a distributed message channel and communication system for mobile devices with Global Position System 104 and wireless networking technologies 102, which is composed of a plurality of devices 100 running applications with the need to establish a network and perform remote functions. The invention includes mobile application SDK 200, a data processing system 400, and a network 103. Network 103 may include one or more networks of the same or different types. Network 103 can be any type of wireless public or private network including a cellular network, a local area network, a wide area network such as the Internet, etc. Network 103 further may be comprised of sub-networks and consist of any number of devices.

The data processing system 400 includes a server computing device 401 and a HTTP or socket connection. Server computing device 401 may be a computer of any form factor. The data processing system accepts HTTP or socket connections from any plurality of mobile device 102. Mobile device may include any device supporting OPS 104 and wireless networking not limited to those devices running iOS, Android, WebOS or Windows. A web application may include any application running in any HTML container or browser on any mobile or non-mobile computing device.

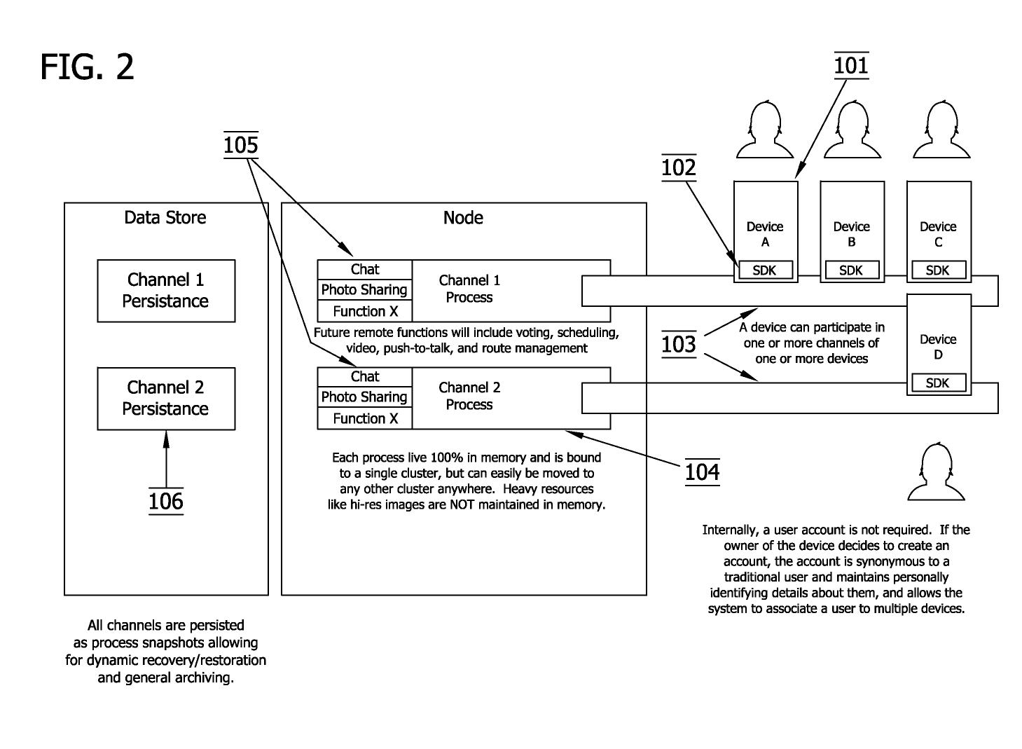

In more detail, still referring to the invention, FIG. 2 depicts another high-level functional diagram detailing the distributed channel architecture of the platform where by a plurality of devices 101 each with the same application written and employing the platforms SDK 102 to establish a channel 103 for the purpose of performing functions 105 such as group chat, photo sharing, or any other function currently deployed or deployed at anytime in the future. Each channel is a fine-grained process 104 that embodies an omni-directional message bus. The state of each channel is persisted by the node to a distributed data store 106.

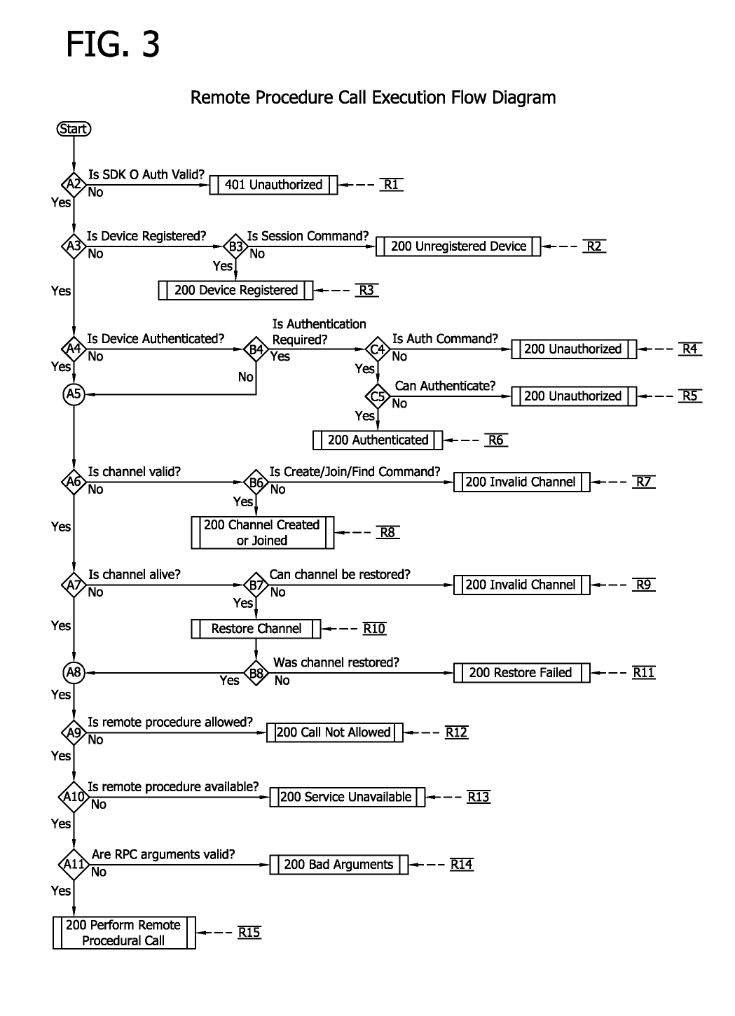

FIG. 3 depicts a flow diagram illustrating the execution of a remote procedure call. The process starts with the accepting of a network request, either of an HTTP protocol, or from a native socket. The caller executes one of many supported remote procedural calls where the arguments of the remote function are passed either as a JSON blob in the request payload for HTTP, or in a binary object when executing over a socket. Whatever result the function generates is returned in the response of the request for HTTP, or via the socket.

At decision point A2, if the caller SDK OAuth is not valid; a 401 Unauthorized response is returned R1.

If it is valid, the process flow continues to decision A3 to determine if the calling device is registered. If no, process flow passes to decision point B3 to determine if the call being executed is a Session Command. If the result of B3 is no, a 200 Unregistered Device message is returned R2. If the result of B3 is yes, a 200 Device Registered is returned to the caller R3.

If the result of decision point A3 is yes, process flow passes to A4 to determine if the device is authenticated. If the result of A4 is no, process flow passes to B4 to determine if authentication is required. If the result of B4 is yes, process flow passes to decision point C4 to determine if the call being executed is an Auth Command. If the result of C4 is no, a 200 Unauthorized response is returned R4. If the result of C4 is yes, the process flow passes to C5 to determine if the system can authenticate the device and user. If the result of C5 is no, a 200 Unauthorized response is returned R5. If the result of C5 is yes, then a 200 Authenticated response is returned R6. If the result of B4 is no, process flow passes to continuation A5 and continues to decision A6. If the result of A4 is yes, process flow passes to continuation A5 and then continues to decision A6.

At decision point A6; the requested channel is determined to be valid. If the result of A6 is no, process flow passes to B6 to determine if the call being executed is either a Create, Join, or Find channel command. If the result of B6 is no, a 200 Invalid Channel response is returned R7. If the result of B6 is yes, then a 200 Channel Created or Channel Joined response is returned R8. If the result of A6 is yes, then process flow passes to A7.

At decision point A7; the requested channel is determined to be alive. If the result of A7 is no, process flow is passed to B7 to determine if the channel can be restored. If the result of B7 is no, a 200 Invalid Channel response is returned R9. If the result of B7 is yes, the channel is restored R10 and process flow passes to B8 to determine if the channel was restored. If the result is no, a 200 Restore Failed is returned R11. If the result of B8 is yes, process flow passes to continuation A8 and continues on to A9. If the result of A7 is yes, process flow passes to continuation A8 and continues on to A9.

At decision point A9; the requested remote procedure is determined to be allowed. If the result of A9 is no, then a 200 Call Not Allowed is returned R12. If the result of A9 is yes, process flow is passed to A10.

At decision point A10; the requested remote procedure is determined to be available. If the result of A10 is no, then a 200 Service Unavailable is returned R13. If the result of A10 is yes, the process flow is passed to A11.

At decision point A11; the requested remote procedure is determined to have valid arguments. If the result of A11 is no, then 200 Bad Arguments is returned R14. If the result of A11 is yes, then the remote procedure call is performed and the result is returned on the requested channel to the caller.

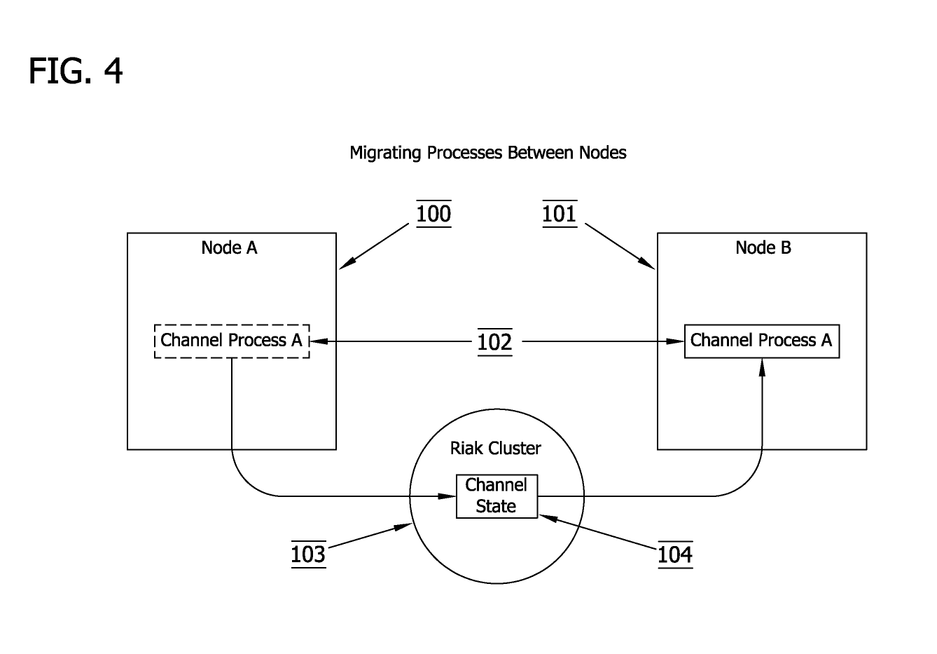

In more detail, still referring to the invention, FIG. 4 depicts a functional diagram of how a given channel can be relocated or restored to a different node. When a channel process is created 102, it is located in the memory of node of the cluster 100. All state changes 104 are persisted to a distributed cluster 103. If a channel is requested to be moved, or restored to either the same or different node, the state 104 is read and restored as a channel process 102 in the new node 101.

The word “example” is used herein to mean serving as an example, instance, or illustration. Any aspect or design described herein as “example” is not necessarily to be construed as preferred or advantageous over other aspects or designs. Further, for the purposes of this disclosure and unless otherwise specified. “a” or “an” means “one or more”. Still further, the use of “and” or “or” is intended to include “and/or” unless specifically indicated otherwise. The example embodiments may be implemented as a method, apparatus, or article of manufacture using standard programming and/or engineering techniques to produce software, firmware, hardware, or any combination thereof to control a computer to implement the disclosed embodiments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A computer platform for providing a service to a plurality of mobile devices, the platform comprising:
a first mobile device;
a second mobile device;
a computer node;
a channel process comprising a message bus in communication with the first mobile device and the second mobile device; and
a data store in communication with the computer node, wherein the data store contains data used by the channel process in performing the service;
wherein the channel process comprises functional logic executed by the computer node in response to a procedural call from the first mobile device to provide the service to the first mobile device.

2. The computer platform of claim 1 wherein the channel process provides the service to the second mobile device.

3. The computer platform of claim 1 further comprising a plurality of additional mobile devices, wherein the channel process provides the service to the plurality of additional mobile devices.

4. The computer platform of claim 1 further comprising a plurality of channel processes and a plurality of additional mobile devices, wherein the plurality of channel processes provide communication between the first mobile device, the second mobile device and the plurality of additional mobile devices.

5. The computer platform of claim 4 wherein the first mobile device, the second mobile device, the plurality of additional mobile devices and the plurality of channel processes are connected in a distributed cluster.

6. The computer platform of claim 1 wherein the first mobile device and the second mobile device run an iOS, Android, WebOS or Windows operating system.
